(19) United States
(12) Patent Application Publication
(10) Pub. No.: US 2008/0163803 A1
(43) Pub. Date: Jul. 10, 2008

(54) METHOD AND SYSTEMS TO CONTROL MUNICIPAL SOLID WASTE DENSITY AND HIGHER HEATING VALUE FOR IMPROVED WASTE-TO-ENERGY BOILER OPERATION

(75) Inventor: Robert L. Barker, Hochessin, DE (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: COVANTA ENERGY CORPORATION, Fairfield, NJ (US)

(21) Appl. No.: 11/961,564

(22) Filed: Dec. 20, 2007

Related U.S. Application Data
(60) Provisional application No. 60/876,581, filed on Dec. 22, 2006.

(51) Int. Cl. F23G 5/50; F23G 5/02; F23G 5/44; F23G 7/00; B09B 3/00; F23N 5/00

(52) U.S. Cl. 110/185; 110/346; 110/235

(57) ABSTRACT

Having an indication of changes to the heating value of municipal solid waste (MSW) and having a means to control it before the MSW is fed to the boiler enables improved combustion control and increased capacity of waste-to-energy boilers. The moisture content of MSW has a significant impact on its heating value and on boiler efficiency when combusted. Changes in moisture content also change the density of the MSW. Directly measuring the density of the MSW prior to feeding it to the boiler permits controlled addition of additional water or liquid waste to reduce the variance of the MSW heating value.

### CROSS REFERENCE TO RELATED APPLICATIONS

This application claims priority under 35 U.S.C. §119(e) from U.S. Provisional Patent Application No. 60/876,581 filed on Dec. 22, 2006, the subject matter of which is herein incorporated by reference.

### FIELD OF THE INVENTION

The present invention relates to an improved Municipal Waste Combustion system and method. Particularly, the embodiments of the present invention improve upon known municipal waste combustors (MWCs) by incorporating means for accurately calculating the moisture content of the input waste to be combusted in the MWC.

### BACKGROUND OF THE INVENTION

In the Waste-to-Energy (WTE) industry, the heating value of municipal solid waste (MSW) is generally considered to be an unmeasurable and uncontrollable variable. Local weather, particularly rainfall, dramatically impacts MSW heating value, and in turn, the processing capacity and operating characteristics of waste-to-energy boilers. This variable is the largest distinction between mass burn waste-to-energy and other forms of combustion-based steam generation. The ability to measure effectively changes in MSW heating value would enhance boiler operation by providing a critical input to boiler combustion controls that has been previously unavailable. In addition, the ability to control the moisture content of the MSW to a relatively constant value, by regulating the addition of water or liquid waste, would further enhance the boiler operation, as well as improve the predictability of waste processing rates, by making constant a previously uncontrolled variable.

It is known to measure moisture content in liquid waste, such as sludge. For example, U.S. Pat. No. 6,553,924 issued to Beaumont, et al. relates to a system and method for injecting and co-combusting sludge in a municipal waste combustor, where the moisture content of the sludge is monitored and controlled prior to combustion, but these techniques are generally not applicable to solid waste management and combustion because it is technically challenging to accurately and efficiently measure the moisture content in large volumes of solid waste in hostile conditions near the MWC furnace.

### SUMMARY OF THE INVENTION

In response to these and other needs, embodiments of the present invention enable direct measuring of the density of the MSW fuel as an indicator of moisture content using nuclear radiation density meters positioned to monitor input waste prior to combustion. In one embodiment, a typical nuclear moisture-density meter contains sealed radioactive materials, typically cesium and a combination of americium mixed with beryllium powder. The radioactive materials emit nuclear radiation that a detector can count when the radiation passes through the MSW. This count can be translated to a density value. The density value can then be used to infer a moisture content measurement for the MSW.

In one aspect of the invention a method for combustion control in solid waste incineration systems is provided. The method includes the steps of feeding solid waste into an input system; determining the moisture content of the solid waste prior to the solid waste entering a combustion chamber; adjusting the combustion process in response to the determined moisture content; and passing the solid waste into the combustion chamber.

In another aspect of the invention a solid waste combustion system is provided. The system includes a municipal waste combustor, the municipal waste combustor including a combustion chamber. The system also includes a waste input system configured to feed solid waste into the combustion chamber. Also included in the system is a moisture sensor adapted to determine moisture content of the solid waste prior to the waste entering the combustion chamber. Finally, the system includes a controller in communication with the moisture sensor, wherein said controller receives information from the moisture sensor and regulates the operation of the municipal waste combustor and/or the waste input system in response to said information.

In embodiments of the present invention, the moisture content measurement for the MSW can be used as a feed forward to the MWC to adjust the combustion process accordingly.

Because radiation-based measurement is a statistically random process, multiple density sensors can be configured in series to measure the waste density several times. Then a final density measure can be determined, for example, from an average reading from the multiple density sensors, with the moisture content estimate produced using the average measured density.

In one embodiment, the density sensor instrument(s) would be situated to read fuel density in a plane passing through the MSW feed hopper just above a ram table where the MSW is forced into a combustion chamber. In this way, the MSW could be measured just prior to introduction into the combustion chamber in the MWC.

Alternatively, multiple measuring points in this plane would ensure a fair representation of the MSW condition.

A smoothed density reading would then be used to characterize the boiler control parameters (such as air distribution and control system gains) to improve combustion control and enhance boiler stability. The MSW density reading would also be used to control liquid injection rates to maintain a relatively constant MSW heating value. The controlled heating value would be at the lower end of the normal range, enabling the boilers to operate close to their grate limit on a continuous basis, and thereby maximize the MSW tons processed, regardless of the variations in MSW composition and heating value.

In one embodiment, the output of this density measurement may be correlated to changes in MSW heating value and used as a feedforward input to the combustion controls.

In another embodiment, the moisture/density measurements may be used to control a water injection process to control the MSW heating value.

### BRIEF DESCRIPTION OF THE DRAWINGS

A more complete understanding of the present invention and advantages thereof may be acquired by referring to the following description taken in conjunction with the accompanying drawings in which like reference numbers indicate like features, and wherein:

FIG. 1 depicts an improved Municipal Waste Combustion (MWC) system in accordance with embodiments of the present invention is presented;

FIG. 2 provides a schematic representation in the form of a longitudinal section through a combustion system of an MWC; and

FIG. 3 provides a flow chart of a method for controlling the heating value of municipal solid waste (MSW) in an MWC.

### DETAILED DESCRIPTION OF THE PREFERRED EMBODIMENTS

As depicted in the figures and as described herein, the embodiments of the present invention provide an improved Municipal Waste Combustion system and method. Specifically, the embodiments of the present invention adapt known municipal waste combustors (MWCs) by incorporating means for accurately calculating the moisture content of the input waste to be combusted in the MWC. Through better measurement of the waste moisture contents, combustion in the MWC can be better controlled to achieve desired results, including reduced emissions and greater combustion efficiency.

Changes in moisture content can alter MSW tons processed as much as 10%, however, waste-to-energy boilers rarely operate at their grate capacity limit. The effect of this idea would be to maintain the boiler close to its grate limit at all times, which should result in an increased MSW throughput of about 5%.

Reduction in fuel variance would also improve consistency of operation resulting in more net power output by minimizing low swings caused by MSW composition and heating value changes.

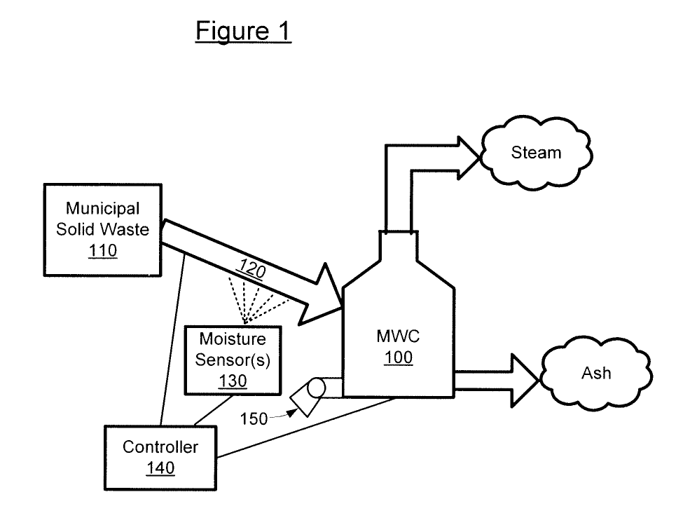

Turning now to FIG. 1, an improved MWC system 100 in accordance with embodiments of the present invention is presented. The MWC system 100 includes a MWC 100 for combusting Municipal Solid Waste (MSW) 110 and a waste input system 120 for supplying the MSW 110 to the MWC 100. Various types of the MWC 100 are known and include, for example, moving grate combustors, rotary-kilns in which waste is transported through the furnace by moving teeth mounted on a central rotating shaft, and fluidized bed in which a strong airflow is forced through a sand bed. Likewise, depending on the type of MWC 110 a variety of kinds of waste input system 120 may be used.

Generally, MSW 110 is burned in the MSC 100 and the energy from the combustion is used to heat water to create high pressure steam. Combustion air from duct 150 and other variables may be adjusted to optimize the combustion process.

One or more moisture sensor 130 is located at a point generally prior to the furnace of the MWC 100 to measure the moisture content of the MSW 110. The moisture sensor 130 may be in the form of a density sensor, such as a nuclear radiation density meter, which indirectly estimates moisture content of the MSW 110. Other types of moisture sensor 130 may include an air humidity sensor located in the vicinity of the MSW 110 combustion. As another alternative, moisture sensor 130 may include a height measurement of the MSW 100 to estimate density and thereby estimate moisture content. Moisture sensor 130 may include a single sensor or multiple sensors of the same type that take measurements at different points in the MSW input stream. Moisture sensor 130 may also include a combination of different types of sensors, such as a nuclear radiation density meter and an air humidity sensor.

Continuing with the improved MWC system 100 in FIG. 1, a controller 140 receives status information from and regulates the operation of the MWC 100 and the waste input system 120. In known systems, the type of information received by the controller 140 typically includes feedback status information from the MWC 100 about combustion process, such as the furnace temperature(s), the measured levels of various output pollutants such as carbon monoxide, and other measured levels such as the amount of elemental oxygen within the furnace. In addition to this conventional information, information from moisture sensor 130 is provided to the controller 140 and used to adjust input flow from the waste input system 120 and the air flow from duct 150. Furthermore, the controller 140 further receives feed-forward information about the status of the waste input system 120. This information typically relates to the amount and timing of municipal waste introduced into the MWC 100.

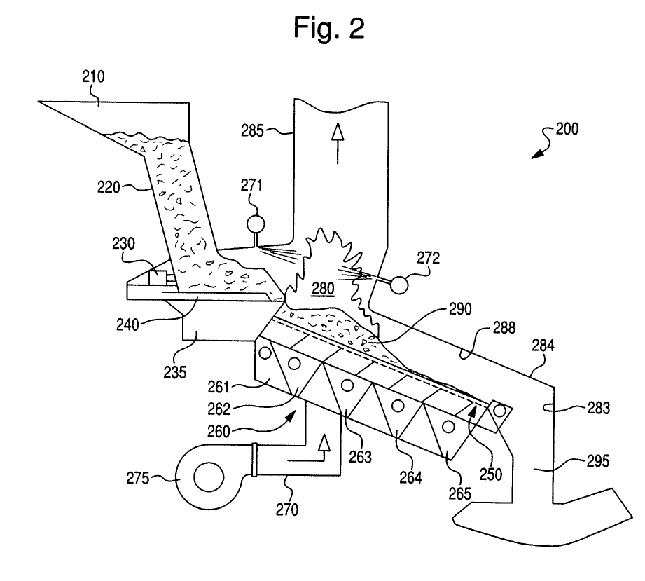

These systems are explained in more detail below by an example of the arrangement in FIG. 2, which is a schematic representation in the form of a longitudinal section through a combustion system 200 of an MWC. While a particular combustion system 200 is depicted in FIG. 2 and described below, it should be appreciated that the principles of the present invention may be adapted to a variety of incineration system to achieve desired optimal MSW processing rates.

As can be seen in FIG. 2, the combustion system 200 in this exemplary embodiment has a feed hopper 210 followed by a feed chute 220 for supplying the fuel to a feed table 235, on which feed rams 240 that can be moved to and fro are provided to convey the fuel arriving from the feed chute 220 onto a combustion grate 250 on which combustion of the fuel takes place. Whether the grate is sloping or is horizontally arranged and which principle is applied is immaterial.

A density meter 230 is located to read fuel density in a plane passing through the feed chute 220 just above the ram table 235. Preferably, multiple measuring points in the same plane may be used to ensure a fair representation of the MSW condition.

Still referring to FIG. 2, a controller (such as controller 140 from FIG. 1) receives status information from a variety of monitored functions and regulates the operation of the MWC 200 and the MSW 290 input. The reading from density meter 230 would also be used by the controller to control liquid (e.g., water or liquid waste) injection rates, such that liquid would be added to comparatively dry waste to maintain a relatively constant MSW heating value. The controlled heating value would be at the lower end of the normal range, enabling the boilers to operate close to their grate limit on a continuous basis, and thereby maximize the MSW tons processed, regardless of the variations in MSW composition and heating value. As a compliment to liquid injection, automatic regulation of other process parameters including excess air ratio, feed water temperature and combustion air preheat temperature may be incorporated in the control strategy to permit process operation at a relatively constant firing rate. The target firing rate would be optimized for the specific financial goal of the facility in which the invention is deployed.

In the representative embodiment shown in FIG. 2, below the combustion grate 250 is arranged a device, denoted in its totality by 260, that supplies primary combustion air and that can consist of several chambers 261 to 265 into which primary combustion air is introduced via a duct 270 by means of a fan 275. Through the arrangement of the chambers 261 to 265, the combustion grate is divided into several underrate air zones so that the primary combustion air can be adjusted to different settings according to the requirements on the combustion grate.

Above the combustion grate 250 is a furnace 280 which leads into a flue gas pass 285 which is followed by components that are not shown, such as a heat recovery boiler and a flue gas cleaning system. The rear area of the furnace 280 is delimited by a roof 288, a rear wall 283 and side walls 284. Combustion of the fuel denoted by 290 takes place on the front part of the combustion grate 250 above which the flue gas pass 285 is located. Most of the primary combustion air is introduced into this area via the chambers 261, 262 and 263. On the rear area of the combustion grate 250 there is only predominantly burnt-out fuel, or bottom ash, and primary combustion air is introduced into this area via the chambers 264 and 265 primarily for cooling purposes and to facilitate residual burnout of the bottom ash.

The burnt-out fuel then falls into a discharger 295 at the end of the combustion grate 250. Optionally, nozzles 271 and 272 are provided in the area of the flue gas pass 285 to supply secondary combustion gas to the rising flue gas, thereby mixing the flue gas flow and facilitating post combustion of the combustible portion remaining in the flue gas.

In certain embodiments of the invention, the improved MWC system described herein may be combined with other known combustion techniques for reducing unwanted emissions such as those described in co-pending and commonly assigned U.S. patent application Ser. Nos. 11/529,292, filed Sep. 29, 2006, and 11/905,809, filed Oct. 4, 2007 which are incorporated herein by reference in their entirety.

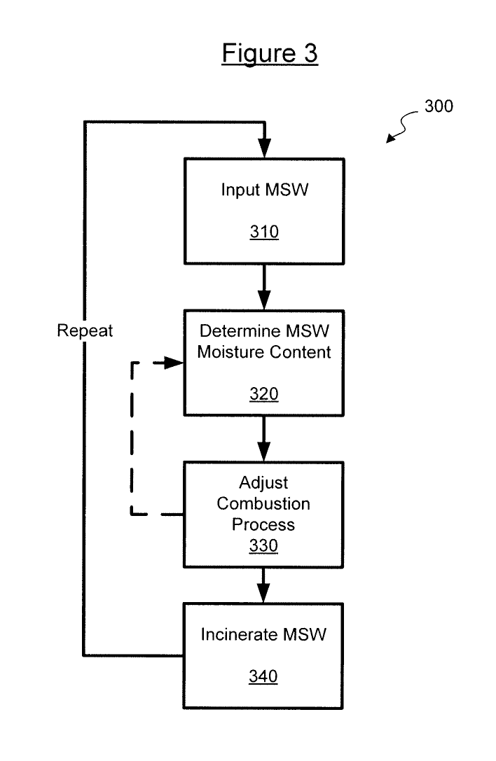

FIG. 3 provides a flow chart of a method 300 for controlling the heating value of MSW in an MWC. In step S310, the MSW is fed into the input system of an MWC. External factors such as weather, waste-types, and transport conditions can effect the heating value of the MSW, and in turn, the processing capacity and operating characteristics of waste-to-energy boilers. Thus, in step S320 the moisture content of the input waste is monitored prior to the waste entering the combustion chamber of the MWC.

In one embodiment, monitoring step S320 is accomplished using one or more nuclear radiation density meters to directly monitoring waste density to estimate moisture content. A typical nuclear moisture-density meter contains sealed radioactive materials, typically cesium and a combination of americium mixed with beryllium powder. The radioactive materials emit nuclear radiation that a detector can count when the radiation passes through the MSW. This count can be translated to a density value. The density value can then be used to infer a moisture content measurement for the MSW.

In step S330, the combustion process is adjusted in response to the monitored reading step S320. As discussed with respect to the previous figures, process variables may be adjusted to maintain a relatively constant MSW heating value. In certain embodiments, the controlled heating value would be at the lower end of the normal range. In step S340 the MSW is forced into the combustion chamber and incinerated, creating heat used for high pressure steam or other energy sources.

While the invention has been described with reference to an exemplary embodiments various additions, deletions, substitutions, or other modifications may be made without departing from the spirit or scope of the invention. Accordingly, the invention is not to be considered as limited by the foregoing description, but is only limited by the scope of the appended claims.

1. A method for combustion control in solid waste incineration systems comprising the steps of:
feeding solid waste into an input system;
determining the moisture content of the solid waste prior to the solid waste entering a combustion chamber;
adjusting the combustion process in response to the determined moisture content; and
passing the solid waste into the combustion chamber.

2. The method of claim 1, wherein the step of determining further comprises identifying a density of the solid waste to estimate moisture content.

3. The method of claim 2, wherein the density of the solid waste is determined using a nuclear radiation density meter.

4. The method of claim 2, wherein the density of the solid waste is determined using a height measurement of the solid waste.

5. The method of claim 1, wherein the moisture content of the solid waste is determined using an air humidity sensor.

6. The method of claim 1, wherein said step of determining the moisture content comprises averaging multiple density readings from the multiple density sensors, with a moisture content estimate produced using the average measured density.

7. The method of claim 1, wherein the combustion process maintains a relatively constant solid waste heating value.

8. The method of claim 1, wherein the adjusting step further comprises regulating the addition of water or liquid waste to the solid waste.

9. A solid waste combustion system comprising:
a municipal waste combustor, said municipal waste combustor including a combustion chamber;
a waste input system configured to feed solid waste into said combustion chamber;
a moisture sensor adapted to determine moisture content of the solid waste prior to said waste entering said combustion chamber; and
a controller in communication with said moisture sensor, wherein said controller receives information from said moisture sensor and regulates the operation of at least one of the municipal waste combustor and the waste input system in response to said information.

10. The system of claim 9, wherein the moisture sensor includes a density sensor to estimate moisture content.

11. The system of claim 9, wherein the density sensor is a nuclear radiation density meter.

12. The system of claim 9, wherein the density sensor uses a height measurement of the solid waste

13. The system of claim 9, wherein the moisture sensor is positioned to monitor the solid waste after the waste is input into the waste input system and prior to combustion.

14. The system of claim 9, wherein the municipal waste combustor further comprises a feed table and wherein said moisture sensor is positioned above said feed table.

15. The system of claim 9, wherein multiple density sensors are configured in series to determine an average waste density.

16. The system of claim 9, wherein said moisture sensor includes an air humidity sensor.

17. The system of claim 16, wherein the moisture sensor further includes a nuclear radiation density meter to estimate moisture content.

18. The system of claim 9, wherein the municipal waste combustor further comprises a liquid injection system and wherein the controller uses information from said moisture sensor to control injections from the liquid injection system.

19. The system of claim 9, wherein the solid waste combustion system maintains a relatively constant solid waste heating value.

20. The system of claim 9, wherein said municipal waste combustor further includes an incineration grate and a device below the incineration grate for feeding primary combustion air in through the incineration grate, said device below the incineration grate being controlled by the controller.

21. The system of claim 20, wherein said municipal waste combustor further includes at least one nozzle that opens into an incineration chamber above the incineration grate for feeding in secondary combustion gas, said at least one nozzle being controlled by the controller.
